(19) United States
(12) Patent Application Publication
(10) Pub. No.: US 2022/0065202 A1
(43) Pub. Date: Mar. 3, 2022

(54) CANISTER

(71) Applicant: FUTABA INDUSTRIAL CO., LTD., Aichi (JP)

(72) Inventor: Koji Iwamoto, Aichi (JP)

(21) Appl. No.: 17/406,507

(22) Filed: Aug. 19, 2021

(30) Foreign Application Priority Data
Aug. 31, 2020 (JP) 2020-145693

(51) Int. Cl. F02M 25/08

(52) U.S. Cl. CPC F02M 25/0854

(57) ABSTRACT

A canister includes a first chamber and a second chamber, an inner wall, a charge port, a purge port, an atmosphere port, and an insulator. An adsorbent is placed in the first chamber and the second chamber. The inner wall is located adjacent to the first chamber and the second chamber, and partitions the first chamber and the second chamber. The insulator is provided to at least one of the first chamber or the second chamber. The insulator is arranged between the adsorbent and the inner wall so as to insulate the adsorbent that is placed in the first chamber or the second chamber, to which the insulator is provided, from the inner wall.

### CROSS-REFERENCE TO RELATED APPLICATIONS

This application claims the benefit of Japanese Patent Application No. 2020-145693 filed on Aug. 31, 2020 with the Japan Patent Office, the entire disclosure of which is incorporated herein by reference.

### BACKGROUND

The present disclosure relates to a canister.

There is a known canister to reduce emission to the atmosphere of evaporated fuel that is generated in a fuel tank of a vehicle. In the canister, an adsorbent (such as activated carbon) for evaporated fuel is placed, and evaporated fuel flowing from a fuel tank into the canister through a charge port is adsorbed by the adsorbent. Also, in the canister, purge is performed to discharge the evaporated fuel adsorbed by the adsorbent toward an engine. Specifically, by causing the atmosphere to flow into the canister through an atmosphere port using an intake air negative pressure of the engine, the evaporated fuel adsorbed by the adsorbent is desorbed, and the desorbed evaporated fuel is supplied to the engine through a purge port.

As disclosed in Japanese Patent No. 4589422, there is also a known canister that comprises a first chamber provided with a charge port and a purge port, and a second chamber provided with an atmosphere port. By providing the second chamber, an improved adsorption performance for evaporated fuel can be achieved.

### SUMMARY

When evaporated fuel is adsorbed by an adsorbent, an exothermic reaction is caused, and an increase in temperature of the adsorbent by the exothermic reaction leads to a decrease in adsorption performance of the adsorbent for evaporated fuel. When evaporated fuel is desorbed from the adsorbent, an endothermic reaction is caused, and a decrease in temperature of the adsorbent by the endothermic reaction leads to a decrease in desorption performance of the adsorbent for the evaporated fuel adsorbed by the adsorbent.

Thus, in the canister of Japanese Patent No. 4589422, a clearance is formed between a wall portion surrounding the first chamber and a wall portion surrounding the second chamber. This configuration can reduce temperature increase of the adsorbent in the second chamber caused by the exothermic reaction when the evaporated fuel flowing through the charge port is adsorbed by the adsorbent in the first chamber, and thus can reduce decrease in adsorption performance of the adsorbent in the second chamber. This configuration can also reduce temperature decrease of the adsorbent in the first chamber caused by the endothermic reaction when the evaporated fuel is desorbed from the adsorbent in the second chamber by the atmosphere flowing in through the purge port, and thus can reduce decrease in desorption performance of the adsorbent in the first chamber.

However, providing the clearance between the wall portion of the first chamber and the wall portion of the second chamber results in an increased arrangement space of the canister, and thus may make it difficult to install the canister in a vehicle.

In one aspect of the present disclosure, it is desirable to facilitate installation of a canister in a vehicle while reducing decrease in adsorption performance and desorption performance for evaporated fuel.

One aspect of the present disclosure is a canister including a casing in which an adsorbent to adsorb evaporated fuel generated in a fuel tank of a vehicle is placed. The canister comprises a first chamber and a second chamber, an inner wall, a charge port, a purge port, an atmosphere port, and an insulator. The first chamber and the second chamber are provided in the casing, and an adsorbent is placed in the first chamber and the second chamber. The inner wall is formed as a part of the casing and located adjacent to the first chamber and the second chamber, and the inner wall partitions the first chamber and the second chamber. The charge port is configured to allow the evaporated fuel to flow into the casing, and is provided to the first chamber. The purge port is configured to discharge the evaporated fuel adsorbed by the adsorbent out of the casing, and the purge port is provided to the first chamber. The atmosphere port is configured to allow an atmosphere to flow into the casing, and the atmosphere port is provided to the second chamber. The insulator is provided to at least one of the first chamber or the second chamber. The insulator is arranged between the adsorbent and the inner wall so as to insulate the adsorbent that is placed in the first chamber or the second chamber, to which the insulator is provided, from the inner wall.

With this configuration, since the first and the second chambers are adjacent to the inner wall, and no clearance is formed between these chambers, an arrangement space for a canister can be reduced. Thus, installation of a canister in a vehicle can be facilitated.

Also, by arranging the charge port, the purge port, or the atmosphere port (hereinafter these are collectively referred to as “ports”) in a vicinity of the inner wall, ports can be located in positions that are impossible for a canister with a clearance between the first chamber and the second chamber. This allows more flexible positioning of ports, and facilitates installation of a canister in a vehicle.

Further, in a case where a clearance is formed between the first chamber and the second chamber, there may be restriction on shapes of parts, which are adjacent to the clearance, of the wall portions of the first and second chambers, and thus positioning of ports may be restricted. In contrast, according to the configuration described above, it is possible to determine the shape of the inner wall more flexibly since there is no clearance between the first chamber and the second chamber. This allows more flexible positioning of ports, and facilitates installation of a canister in a vehicle.

Moreover, since the adsorbent is insulated from the inner wall by the insulator in at least one of the first chamber or the second chamber, heat transmission between the adsorbent in the first chamber and the adsorbent in the second chamber can be reduced. Accordingly, if evaporated fuel is adsorbed by the adsorbent in one of the first chamber and the second chamber, and an exothermic reaction is caused, it is possible to inhibit temperature increase in the other chamber and resulting decrease in adsorption performance of the adsorbent in the other chamber. Also, if evaporated fuel is desorbed from the adsorbent in one of the first chamber and the second chamber, and an endothermic reaction is caused, it is possible to inhibit temperature decrease in the other chamber and resulting decrease in desorption performance of the adsorbent in the other chamber.

This facilitates installation of a canister in a vehicle while reducing decrease in adsorption performance and desorption performance for evaporated fuel.

The insulator may form a space between the inner wall and the adsorbent placed in the first chamber or the second chamber, to which the insulator is provided.

According to this configuration, heat transmission between the adsorbent in the first chamber and the adsorbent in the second chamber can be reduced more effectively.

The insulator may be configured as a tubular member such that the adsorbent is placed inside the insulator.

According to this configuration, by changing the size of the insulator, the quantity and an L/D ratio of the adsorbent inside the insulator can be adjusted easily. Here, L means a length of an arrangement area of the adsorbent in a flow direction of evaporated fuel, and D means an equivalent diameter of the arrangement area in a cross-section orthogonal to the flow direction. Thus, by changing the size of the insulator while using the same casing, the quantity and the L/D ratio of the adsorbent in the chamber to which the insulator is provided can be adjusted depending on a type of vehicle. Accordingly, it is possible to achieve commonality of the whole or a part of a casing for a canister to be installed in a plurality of types of vehicles, and to reduce manufacturing costs of the canister.

The insulator may be formed of a material having heat insulating property.

According to this configuration, heat transmission between the adsorbent in the first chamber and the adsorbent in the second chamber can be reduced more effectively.

The insulator may be provided to the second chamber.

According to this configuration, if evaporated fuel flowing through the charge port is adsorbed by the adsorbent and an exothermic reaction is caused in the first chamber, it is possible to inhibit heat transmission to the second chamber and resulting decrease in adsorption performance of the adsorbent in the second chamber. Also, if evaporated fuel is desorbed from the adsorbent by the atmosphere flowing through the atmosphere port, and an endothermic reaction is caused in the second chamber, it is possible to inhibit temperature decrease of the adsorbent in the first chamber and resulting decrease in desorption performance of the adsorbent. Accordingly, decrease in adsorption performance and desorption performance for evaporated fuel can be reduced.

The first chamber and the second chamber may each extend along a first direction, and the first chamber and the second chamber may each comprise a first end of both ends facing each other along the first direction. Also, the charge port and the purge port may be provided at the first end of the first chamber, and the atmosphere port may be provided at the first end of the second chamber. Further, the casing may comprise a first wall portion and a second wall portion facing each other, the first wall portion and the second wall portion may face the first chamber and the second chamber, respectively, and the inner wall may extend from the first wall portion to the second wall portion. Moreover, at least a part of the inner wall may be oblique to a direction along which the first wall portion and the second wall portion face each other, or may be curved in a cross-section orthogonal to the first direction.

According to this configuration, at least a part of the inner wall is oblique to the direction along which the first wall portion and the second wall portion face each other, or curved in the cross-section orthogonal to the first direction. Accordingly, it is possible to arrange ports in positions different from those in the case where the inner wall is parallel to the direction along which the first wall portion and the second wall portion face each other. This allows more flexible positioning of ports, and facilitates installation of a canister in a vehicle.

### BRIEF DESCRIPTION OF THE DRAWINGS

Some embodiments of the present disclosure will be described hereinafter by way of example with reference to the accompanying drawings, in which:

FIG. 1 is a sectional view of a canister orthogonal to a third direction;

FIG. 2 is a sectional view of an outer wall and an inner wall of a casing of the canister orthogonal to a first direction;

FIG. 3 is a sectional view of an outer wall and an inner wall of a modified example of a casing of the canister orthogonal to the first direction;

FIG. 4 is a sectional view of an outer wall and an inner wall of a modified example of a casing of the canister orthogonal to the first direction;

FIG. 5 is an explanatory view of a manufacturing process of the casing of the canister; and

FIG. 6 is an explanatory view of a manufacturing process of a casing of a canister having a clearance between a first chamber and a second chamber.

### DETAILED DESCRIPTION OF EXEMPLARY EMBODIMENTS

Embodiments of the present disclosure are not limited to the embodiments described below, but may be in various forms within the technical scope of the present disclosure.

### 1. OUTLINE OF CANISTER

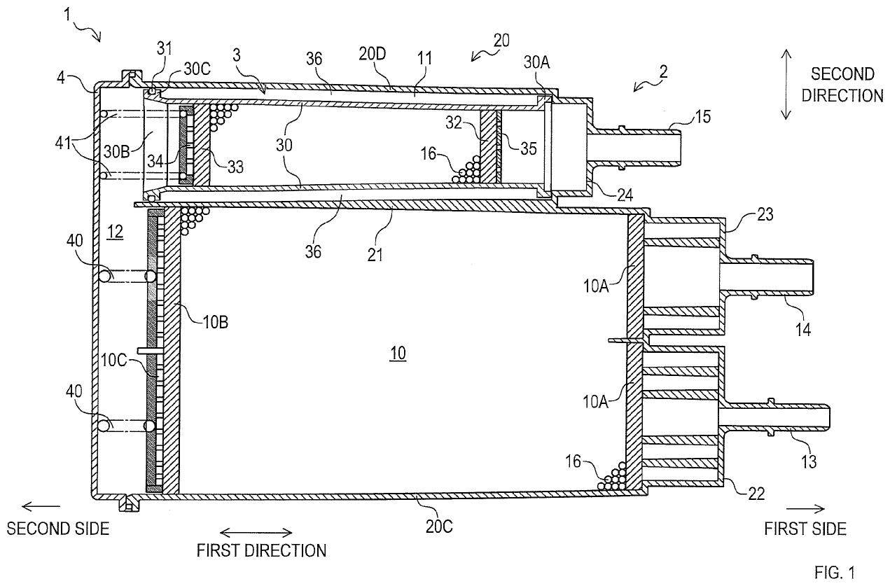

A canister 1 of the present embodiment is installed in a vehicle, and adsorbs evaporated fuel generated in a fuel tank of the vehicle, to thereby reduce flow of the evaporated fuel out of the vehicle (see FIG. 1). Also, the canister 1 takes in the atmosphere and performs purge, to thereby cause adsorbed evaporated fuel to flow into an engine of the vehicle.

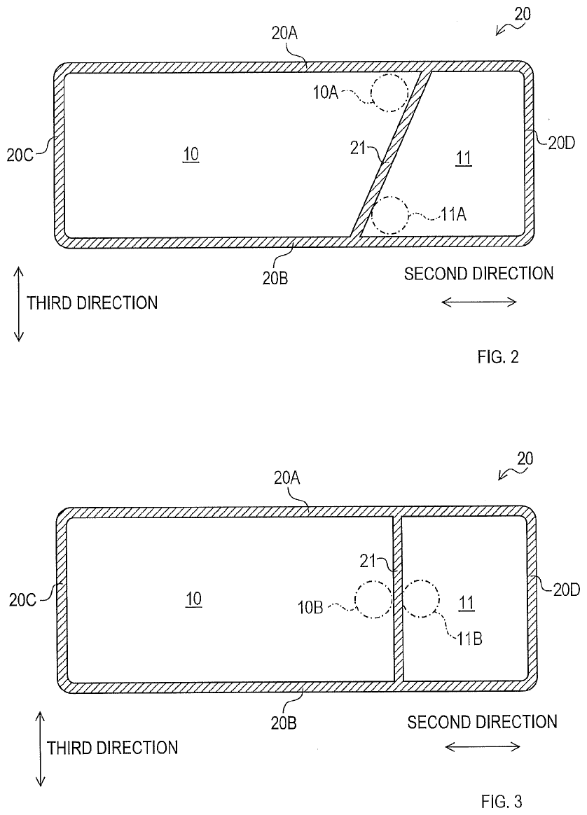

The canister 1 comprises a first chamber 10, a second chamber 11, a connection path 12, a purge port 13, a charge port 14, an atmosphere port 15, and an activated carbon 16 (see FIGS. 1 and 2).

The activated carbon 16 as an adsorbent of evaporated fuel is placed in the first and the second chambers 10, 11. Any adsorbent other than the activated carbon 16 may be placed in the first and the second chambers 10, 11. The first and the second chambers 10, 11 each extend along a first direction. The first and the second chambers 10, 11 are located side by side along a second direction orthogonal to the first direction. Hereinafter, a direction orthogonal to the first and the second direction is referred to as a third direction. Also, one side facing the first direction is referred to as a first side, and the other side is referred to as a second side.

A filter 10A and a filter 10B are placed, respectively, on the first side and the second side of the first chamber 10, and the activated carbon 16 of the first chamber 10 is contained between the filter 10A and the filter 10B. Adjacent to the second side of the filter 10B, a grid 10C with multiple holes allowing passage of fluid is placed.

On the other hand, an inner case 3 (detailed below) containing the activated carbon 16 is arranged in the second chamber 11.

The connection path 12 communicates the first chamber 10 and the second chamber 11 with each other. The connection path 12 is connected to an end of the first chamber 10 on the second side and an end of the second chamber 11 on the second side, and fluid is movable between the first chamber 10 and the second chamber 11 through the connection path 12.

The charge port 14 is provided at an end on the first side (in other words, a first end) of the first chamber 10, and is connected to a fuel tank of the vehicle through a valve. Evaporated fuel generated from fuel stored in the fuel tank flows into the canister 1 through the charge port 14, and is adsorbed by the activated carbon 16 in the first and the second chambers 10, 11. As a result, the evaporated fuel is accumulated in the canister 1.

The purge port 13 is provided at the end on the first side of the first chamber 10, and is connected to an intake pipe of the engine of the vehicle through a valve.

The atmosphere port 15 is provided at an end on the first side (in other words, a first end) of the second chamber 11, and communicates with outside of the vehicle.

By causing the atmosphere (hereinafter, “purge air”) to flow into the canister 1 through the atmosphere port 15 using an intake air negative pressure of the engine, the aforementioned purge is performed. In the first and the second chambers 10, 11, the evaporated fuel adsorbed by the activated carbon 16 is desorbed by the purge air that has flown in, and the desorbed evaporated fuel flows out through the purge port 13 toward the intake pipe. As a result, the evaporated fuel adsorbed by the activated carbon 16 is removed, and the activated carbon 16 is regenerated.

The canister 1 also comprises a casing 2 and a lid 4, and these portions form the first chamber 10, the second chamber 11, and the connection path 12. Descriptions will be given of the casing 2 and the lid 4, as well as the aforementioned inner case 3.

### 2. CASING

The casing 2 is a portion having a generally parallelepiped shape and made of resin, for example. The first and the second chambers 10, 11 are provided in the casing 2. The casing 2 comprises an outer wall 20, an inner wall 21, and first to third bottom portions 22 to 24 (see FIGS. 1, 2).

The outer wall 20 is a wall-like portion surrounding the first and the second chambers 10, 11. The outer wall 20 comprises first and second wall portions 20A, 20B facing the first and the second chambers 10, 11. The first wall portion 20A and the second wall portion 20B face each other along the third direction. In the present embodiment, by way of example, the first and the second wall portions 20A, 20B each extend substantially flat along the second direction. However, the first and the second wall portions 20A, 20B may be oblique to the second direction or may be curved. Also, the outer wall 20 comprises a third wall portion 20C facing the first chamber 10 and a fourth wall portion 20D facing the second chamber 11. The third wall portion 20C and the fourth wall portion 20D face each other along the second direction. In the present embodiment, by way of example, the third and the fourth wall portions 20C, 20D each extend substantially flat along the third direction. However, the third and the fourth wall portions 20C, 20D may be oblique to the third direction or may be curved.

The inner wall 21 is arranged inside the outer wall 20 to partition an inner space of the outer wall 20 into the first chamber 10 and the second chamber 11. The inner wall 21 extends from an inner peripheral surface of the first wall portion 20A to an inner peripheral surface of the second wall portion 20B, and is adjacent to the first and the second chambers 10, 11. Also, the inner wall 21 extends flat and obliquely to the third direction.

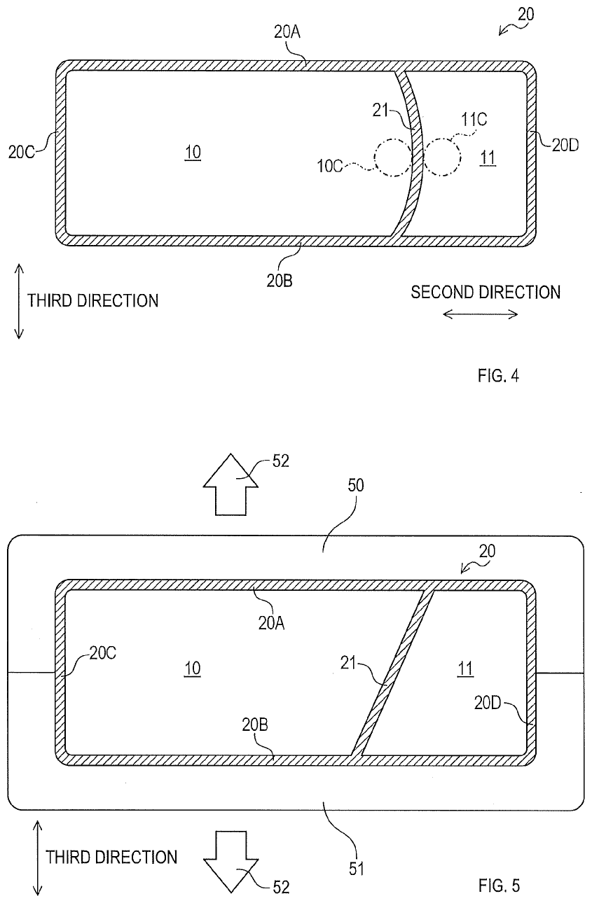

The inner wall 21 may, for example, extend flat along the third direction (see FIG. 3). Also, the inner wall 21 may have a curved shape in a cross-section orthogonal to the first direction (see FIG. 4). Further, a part of the inner wall 21 may be oblique to the third direction, or may have a curved shape in a cross-section orthogonal to the first direction.

The first and second bottom portions 22, 23 are provided so as to cover an end of the first chamber 10 on the first side. The first bottom portion 22 comprises the purge port 13, and the second bottom portion 23 comprises the charge port 14.

A third bottom portion 24 is provided so as to cover an end of the second chamber 11 on the first side. The third bottom portion 24 comprises the atmosphere port 15.

The purge port 13, the charge port 14, and the atmosphere port 15 may be positioned appropriately, and these ports may be arranged in a vicinity of the inner wall 21. Arranging a port in the vicinity of the inner wall 21 may include an arrangement of the port such that, when the port is moved along the first direction toward the second side, the port is positioned to abut or become close to the inner wall 21. Specifically, the purge port 13 or the charge port 14 may be arranged in any of positions 10A to 10C in FIGS. 2 to 4, and the atmosphere port 15 may be arranged in any of positions 11A to 11C.

### 3. INNER CASE

The inner case 3 is configured to contain the activated carbon 16, and is arranged in the second chamber 11 (see FIG. 1). The inner case 3 comprises a main body 30, a seal member 31, filters 32, 33, a grid 34, and a partition wall plate 35.

The main body 30 is a cylindrical portion, and is arranged in the second chamber 11 so as to extend along the first direction. The main body 30 is not limited to a cylindrical shape but may be formed as a tubular member having various shapes. Specifically, for example, a cross-section of the main body 30 orthogonal to the first direction may be a polygon.

The activated carbon 16 is placed inside the main body 30, and a part of the main body 30 is located between the activated carbon 16 and the inner wall 21. The filters 32, 33 are arranged on the first side and the second side, respectively, of the activated carbon 16. The partition wall plate 35 having multiple holes that allow passage of fluid is arranged adjacent to the first side of the filter 32. The grid 34 having multiple holes that allow passage of fluid is arranged adjacent to the second side of the filter 33. The partition wall plate 35 is arranged a specified distance apart from an opening of the main body 30 on the first side, and the grid 34 is arranged a specified distance apart from an opening of the main body 30 on the second side.

An abutting portion 30A is provided at an end of the main body 30 on the first side, and an opening portion 30B and a flange portion 30C are provided at an end of the main body 30 on the second side.

The abutting portion 30A forms a rim surrounding the opening of the main body 30 on the first side, and protrudes outward, and an outer periphery of the abutting portion 30A protrudes toward the first side. The abutting portion 30A abuts the casing 2 at the end of the main body 30 on the first side. Specifically, the abutting portion 30A abuts a stepped portion provided at the end of the second chamber 11 on the first side in the casing 2.

The opening portion 30B includes the end of the main body 30 on the second side, and has a diameter increasing toward the second side. The flange portion 30C surrounds the opening of the main body 30 on the second side, and protrudes outward. An outer-circumferential surface of the flange portion 30C comprises a groove surrounding the opening of the main body 30 on the second side, and the seal member 31 (for example, an O-ring) is placed in the groove.

In the inner case 3 arranged in the second chamber 11, the abutting portion 30A, the flange portion 30C, and the seal member 31 abut the casing 2, while a space 36 is formed between a part of the main body 30 except for the abutting portion 30A and the flange portion 30C, and each of the outer wall 20 and the inner wall 21. The space 36 surrounds the main body 30 extending over an entire arrangement area of the activated carbon 16. Thus, the space 36 is located between the entire arrangement area of the activated carbon 16 and the inner wall 21, and the activated carbon 16 in the second chamber 11 is insulated from the inner wall 21 of the casing 2. In the space 36, a heat insulating material, such as glass wool, may be placed. Also, the main body 30 may be formed of a material having heat insulating property.

An end of the space 36 on the first side abuts the abutting portion 30A, and an end of the space 36 on the second side is sealed by the seal member 31 provided in the flange portion 30C. This configuration inhibits evaporated fuel inside the canister 1 from flowing into the space 36.

### 4. LID

The lid 4 is provided to cover the respective ends of the first and the second chambers 10, 11 on the second side, which are formed by the outer wall 20 (see FIG. 1). The aforementioned connection path 12 is formed between the lid 4 and the respective ends of the first and the second chambers 10, 11 on the second side. Also, the lid 4 comprises first and second springs 40, 41.

The first springs 40 are provided between an inner peripheral surface of the lid 4 and the grid 10C provided on the second side of the first chamber 10, and the first springs 40 bias the grid 10C toward the first side.

The second springs 41 are provided between the inner peripheral surface of the lid 4 and the grid 34 in the inner case 3 of the second chamber 10, and the second springs 41 bias the grid 34 toward the first side.

### 5. MANUFACTURING PROCESS OF CASING

A manufacturing process of the outer wall 20 in the casing 2 of the canister 1 comprises a first process and a second process described below.

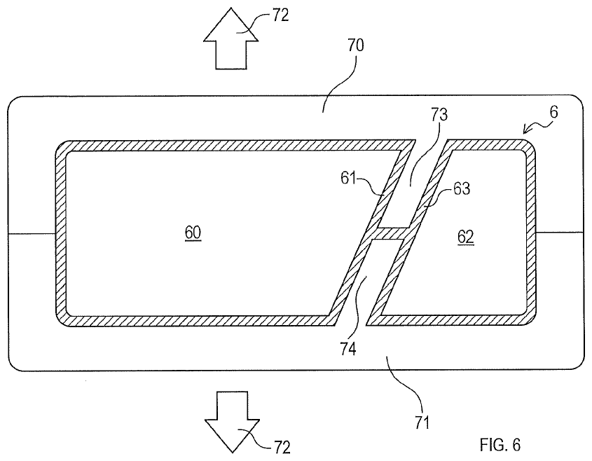

In the first process, a first and a second metal molds 50, 51 for forming an outer peripheral surface of the outer wall 20 of the casing 2 are placed to face each other (see FIG. 5).

In the subsequent second process, resin in a molten state is injected between the first metal mold 50 and the second metal mold 51, and the resin is cured. When curing of the resin is completed, the first and the second metal molds 50, 51 are separated from each other. As a result, the outer peripheral surface of the outer wall 20 is formed. Directions 52 in which the first and the second metal molds 50, 51 are displaced when the first and the second metal molds 50, 51 are separated from each other in the second process are parallel to the third direction for the outer wall 20 of the casing 2 located in the first and the second metal molds 50, 51.

Outer peripheral surfaces of the first to the third bottom portions 22 to 24, the purge port 13, the charge port 14, and the atmosphere port 15 may be formed using the first and the second metal molds 50, 51 in the first and the second processes. Also, the inner peripheral surface of the outer wall 20 and the inner wall 21 may be formed using another metal mold that is placed between the first metal mold 50 and the second metal mold 51.

### 6. EFFECTS

(1) According to the embodiment described above, the first and the second chambers 10, 11 are adjacent to the inner wall 21, and there is no clearance between these chambers; thus, an arrangement space for the canister 1 can be reduced. This facilitates installation of the canister 1 in a vehicle.

Also, by arranging ports in the vicinity of the inner wall 21, ports can be located in positions that are impossible for a canister with a clearance between the first chamber and the second chamber. This allows more flexible positioning of ports, and facilitates installation of a canister in a vehicle.

Further, in a case where a clearance is formed between the first chamber and the second chamber, there may be restrictions on shapes of parts, which are adjacent to the clearance, of the wall portions of the first and the second chambers. Specifically as shown in FIG. 6, in a case where a clearance is formed between a wall portion 61 of a first chamber 60 and a wall portion 63 of a second chamber 62 in a casing 6, it is required to provide projections 73, 74 for forming outer peripheral surfaces of the wall portions 61, 63 to metal molds 70, 71 for forming an outer peripheral surface of the casing 6. Thus, if the wall portions 61, 63 are, for example, oblique to separating directions 72 as shown in FIG. 6, or the wall portions 61, 63 are curved, then the metal molds 70, 71 cannot be displaced in the separating directions 72. The separating directions 72 here mean directions of separating the metal mold 70 and the metal mold 71 from each other after curing of resin injected inside the metal molds 70, 71 for forming the casing 6. Accordingly, the wall portion 61 of the first chamber 60 and the wall portion 63 of the second chamber 62 are required to be parallel to the separating directions 72, and thus, positioning of ports in the first and the second chambers 60, 62 might be restricted.

In contrast, according to the embodiment described above, it is possible to determine the shape of the inner wall 21 flexibly since there is no clearance between the first chamber 10 and the second chamber 11. This allows more flexible positioning of ports, and facilitates installation of a canister in a vehicle.

Moreover, in the second chamber 11, the inner case 3 insulates the activated carbon 16 from an entire area of the inner wall 21, and thus, heat transmission can be reduced between the activated carbon 16 in the first chamber 10 and the activated carbon 16 in the second chamber 11. Accordingly, if evaporated fuel flowing through the charge port 14 is adsorbed by the activated carbon 16 in the first chamber 10, and an exothermic reaction is caused, it is possible to inhibit heat transmission to the second chamber 11 and resulting decrease in adsorption performance of the activated carbon 16 in the second chamber 11. Also, if evaporated fuel is desorbed from the activated carbon 16 in the second chamber 11 by the atmosphere that has flown through the atmosphere port 15, and an endothermic reaction is caused, it is possible to inhibit temperature decrease of the activated carbon 16 in the first chamber 10 and resulting decrease in desorption performance of the activated carbon 16.

This facilitates installation of the canister 1 in a vehicle while reducing decrease in adsorption performance and desorption performance for evaporated fuel.

(2) In the second chamber 11, the inner case 3 provides the space 36 between the activated carbon 16 and the inner wall 21. Accordingly, heat transmission between the activated carbon 16 in the first chamber 10 and the activated carbon 16 in the second chamber 11 can be reduced more effectively.

(3) In the second chamber 11, the activated carbon 16 is contained in the main body 30 of the inner case 3. Thus, by changing the size of the main body 30, the quantity and the L/D ratio of the activated carbon 16 in the second chamber 11 can be easily adjusted. Also, by changing the size of the main body 30 while using the same casing, the quantity and the L/D ratio of the activated carbon 16 in the second chamber 11 can be adjusted depending on a type of vehicle. Accordingly, it is possible to achieve commonality of the whole or a part of the casing 2 for the canister 1 to be installed in a plurality of types of vehicles, and to reduce manufacturing costs of the canister 1.

(4) The inner wall 21 is oblique to the third direction along which the first wall portion 20A and the second wall portion 20B face each other. Accordingly, it is possible to arrange ports in positions different from those in the case where the inner wall 21 is parallel to the third direction. This allows more flexible positioning of ports, and facilitates installation of the canister 1 in a vehicle.

### 7. OTHER EMBODIMENTS

(1) In the embodiment described above, the activated carbon 16 is contained in the main body 30 of the inner case 3 in the second chamber 11, and thus the space 36 is formed between the activated carbon 16 and each of the inner wall 21 and the outer wall 20. However, the inner case 3 may be configured, for example, such that the main body 30 abuts the inner wall 21 and the outer wall 20, leaving no space between the activated carbon 16 and an inside wall of the second chamber 11. In this case, it is preferable to form the main body 30 of a material having heat insulating property. Such configuration can also achieve the similar effects.

(2) In place of the inner case 3, a plate-shaped insulator may be arranged between the activated carbon 16 in the second chamber 11 and the inner wall 21, to thereby contain the activated carbon 16 between the outer wall 20 and the insulator, and insulate the activated carbon 16 from the entire area of the inner wall 21. In this case, a space may be formed between the insulator and the inner wall 21, and also a heat insulating material, such as glass wool, may be placed in the space. Alternatively, the insulator may be configured to abut the inner wall 21. In this case, it is preferable to form the insulator of a material having heat insulating property. Such configuration can also achieve the similar effects.

(3) The inner case in the embodiment described above may be configured in a shape corresponding to the first chamber 10. Then, such inner case containing activated carbon in a similar manner as in the embodiment described above, or other embodiment (1) above, may be arranged in the first chamber 10. Further, the insulator in other embodiment (2) above may be configured in a shape suitable for the first chamber 10. Then, such insulator may be arranged in the first chamber 10, to thereby contain the activated carbon 16 between the insulator and the outer wall 20, and insulate the activated carbon 16 in the first chamber 10 from the entire area of the inner wall 21.

In this case, the inner case 3 or the insulator may also be provided in the second chamber 11, or the activated carbon 16 may be contained in the second chamber 11 without using the inner case 3 or the insulator. Such configuration can also achieve the similar effects.

(4) In the embodiment described above, the second chamber 11 may be configured by two or more chambers aligned in the first direction. In this case, it may be configured such that the activated carbon is insulated from the entire area of the inner wall 21 in each of the chambers in a similar manner as in the embodiment described above, other embodiment (1), or other embodiment (2). Such configuration can also achieve the similar effects.

(5) In the embodiment described above, the abutting portion 30A provided at the end of the main body 30 on the first side may be configured as a flange-like portion protruding outward. Such configuration can also achieve the similar effects.

(6) A plurality of functions performed by a single element in the aforementioned embodiments may be achieved by a plurality of elements, or a function performed by a single element may be achieved by a plurality of elements. Also, a plurality of functions performed by a plurality of elements may be achieved by a single element, or a function performed by a plurality of elements may be achieved by a single element. Further, a part of a configuration in the aforementioned embodiments may be omitted. Moreover, at least a part of a configuration in the aforementioned embodiments may be added to, or may replace, another configuration in the aforementioned embodiments.

### 8. CORRESPONDENCE OF TERMS

The main body 30 of the inner case 3 in the aforementioned embodiments corresponds to one example of an insulator.

What is claimed is:

1. A canister including a casing in which an adsorbent to adsorb evaporated fuel generated in a fuel tank of a vehicle is placed, the canister comprising:
a first chamber and a second chamber provided in the casing, the adsorbent being placed in the first chamber and the second chamber;
an inner wall formed as a part of the casing and located adjacent to the first chamber and the second chamber, the inner wall partitioning the first chamber and the second chamber;
a charge port configured to allow the evaporated fuel to flow into the casing, the charge port being provided to the first chamber;
a purge port configured to discharge the evaporated fuel adsorbed by the adsorbent out of the casing, the purge port being provided to the first chamber;
an atmosphere port configured to allow an atmosphere to flow into the casing, the atmosphere port being provided to the second chamber; and
an insulator provided to at least one of the first chamber or the second chamber,
wherein the insulator is arranged between the adsorbent and the inner wall so as to insulate the adsorbent that is placed in the first chamber or the second chamber, to which the insulator is provided, from the inner wall.

2. The canister according to claim 1,
wherein the insulator forms a space between the inner wall and the adsorbent placed in the first chamber or the second chamber to which the insulator is provided.

3. The canister according to claim 1,
wherein the insulator is configured as a tubular member such that the adsorbent is placed inside the insulator.

4. The canister according to claim 1,
wherein the insulator is formed of a material having heat insulating property.

5. The canister according to claim 1,
wherein the insulator is provided to the second chamber.

6. The canister according to claim 1,
wherein the first chamber and the second chamber each extend along a first direction, and the first chamber and the second chamber each comprise a first end of both ends facing each other along the first direction,
wherein the charge port and the purge port are provided at the first end of the first chamber,
wherein the atmosphere port is provided at the first end of the second chamber,
wherein the casing comprises a first wall portion and a second wall portion facing each other, and the first wall portion and the second wall portion face the first chamber and the second chamber, respectively,
wherein the inner wall extends from the first wall portion to the second wall portion, and
wherein at least a part of the inner wall is oblique to a direction along which the first wall portion and the second wall portion face each other.

7. The canister according to claim 1,
wherein the first chamber and the second chamber each extend along a first direction, and the first chamber and the second chamber each comprise a first end of both ends facing each other along the first direction,
wherein the charge port and the purge port are provided at the first end of the first chamber,
wherein the atmosphere port is provided at the first end of the second chamber,
wherein the casing comprises a first wall portion and a second wall portion facing each other, and the first wall portion and the second wall portion face the first chamber and the second chamber, respectively,
wherein the inner wall extends from the first wall portion to the second wall portion, and
wherein at least a part of the inner wall is curved in a cross-section orthogonal to the first direction.
